(19) United States
(12) Patent Application Publication
(10) Pub. No.: US 2007/0298382 A1
(43) Pub. Date: Dec. 27, 2007

(54) Virtual textile samples and displays

(76) Inventor: Lee H. Schilling, Lookout Mountain, GA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/810,473

(22) Filed: Jun. 6, 2007

Related U.S. Application Data
(60) Provisional application No. 60/811,705, filed on Jun. 7, 2006.

(51) Int. Cl. G09B 25/00

(52) U.S. Cl. 434/75

(57) ABSTRACT

A display for a textile comprises a textile specimen and at least one virtual representation of the textile specimen. The virtual representation of the textile specimen may be provided in the same color scheme as the textile specimen or in another color scheme. The virtual representation may be embodied in a card or sheet that is intended to be separated from the remainder of the display. A method of providing a customized textile specimen also is disclosed.

### CROSS-REFERENCE TO RELATED APPLICATION

The benefit of U.S. Provisional Application No. 60/811,705, filed Jun. 7, 2006, which is incorporated by reference herein in its entirety, is hereby claimed.

### BACKGROUND

It is common in textile industries, particularly the carpet industry, to assemble a collection of actual carpet samples or “specimens” into a sample book or portfolio to present to a potential purchaser. The sample book typically includes a large specimen of a first color of the carpet, and several additional, smaller specimens or “chips” of different colors, each of which comprises an actual cut piece of carpet. Often the large specimen is affixed to a book and the smaller specimens displaying the alternate colors either are affixed to the book or are seated removably within a molded plastic holder or other type of holder inside the book. By configuring the sample book in this manner, the purchaser may view a large specimen of the carpet to evaluate the overall visual and tactile aesthetics of the carpet, but also may view alternate colors of the same carpet at the same time.

Often, it is desirable for a purchaser to retain specimens of interest for comparison with paint colors, furniture, and other decorating components. However, since only a single specimen of each color typically is provided in the book, if any specimens are removed from the book and not replaced, the book is rendered incomplete for the next buyer. As a result, sales personnel either are required to carry large quantities of pre-cut carpet specimens that can be retained by the buyer, or must carry numerous sample books for each carpet collection so the entire book can be provided to the buyer. While both approaches likely satisfy the buyer's needs, such approaches are both costly and cumbersome for the manufacturer.

In some instances, the purchaser may request a particular color or color combination that is not available in the sample book or one that is not presently offered by the carpet manufacturer. In such instances, it is typical for the purchaser to request specimens having various color schemes and then to wait several weeks for the manufacturer to fabricate the specimens. This process is both undesirably costly for the manufacturer and inconvenient for the purchaser.

As such, there is a need for a convenient manner of displaying textiles that both maintains the ability for a purchaser to evaluate the tactile and aesthetic properties of a complete textile collection and allows the purchaser to retain a specimen of a particular color of interest without removing or defacing the sample book. There further is a need for an improved process for preparing and evaluating custom color combinations for a particular textile.

### SUMMARY

The present invention is directed generally to a substantially accurate image or representation (“representation” or “virtual representation”) of a textile, for example, a carpet, carpet tile, rug, or fabric. The invention further is directed to a collection or compilation of such representations.

If desired, the representation may be printed onto or otherwise presented on a tangible medium such as a paper sheet to form a “virtual sample” or “virtual textile sample.” Alternatively or additionally, the representation may be embodied in a textile sample book, textile sample sheet, textile sample card, or other textile sample display (collectively “display”). The invention also is directed to a method of using a representation to provide a customized textile specimen and/or a virtual textile sample.

The use of such representations, virtual textile samples, displays, and methods substantially reduces the need to prepare, store, and transport large quantities of costly and cumbersome conventional textile sample books and significantly simplifies the process of preparing and evaluating custom textile specimens.

In one particular aspect, a display for a textile comprises a textile specimen and a virtual representation of the textile specimen. The virtual representation of the textile specimen generally comprises a substantially accurate image of the textile specimen. The substantially accurate image may comprise a photograph, a digitally altered photograph, an electronically-generated image, or any combination thereof.

In one variation, the virtual representation of the textile specimen is printed onto a substrate. In one particular example, the display comprises at least one panel, and the virtual representation of the textile specimen printed onto the substrate is removably joined to the panel. In an alternate example, the virtual representation of the textile specimen printed onto the substrate is not removably joined to the panel.

In another variation, the textile specimen is provided in a first color scheme, the virtual representation of the textile specimen is a first virtual representation of the textile specimen in the first color scheme, and the display further comprises a second virtual representation of the textile specimen in a second color scheme.

In another aspect, a display for a textile comprises a textile specimen having a color scheme and a set of removable cards, where each of the cards comprises a substantially accurate representation of the textile specimen having the first color scheme. The display may further comprise a dimensionally stable panel, where the set of removable cards is removably affixed to the dimensionally stable panel. In one variation, the set of removable cards overlies a substantially accurate representation of the textile specimen having the first color scheme adjoined to the dimensionally stable panel.

If desired, the set of removable cards may be arranged in a stacked configuration. In one example, the set of removable cards is arranged as a stack, and the removable cards are adjoined to one another proximate to a first end of the stack. In another example, each of the removable cards in the set of removable cards is adjoined to an adjacent card by an adhesive. In still another example, the set of removable cards is arranged as a stack with an outermost card at least partially concealing a next card. Upon removal of the outermost card, the next card becomes available for removal. In yet another example, the set of removable cards is a first set of removable cards, the display further comprises a second set of removable cards, and each of the cards in the second set of removable cards comprises a substantially accurate representation of the textile specimen having a second color scheme.

In another aspect, the invention is directed to a plurality of virtual textile samples in a stack, where each virtual textile sample comprises a substantially accurate representation of a textile specimen. If desired, adjacent virtual textile samples in the stack may be joined to one another using an adhesive. Alternatively or additionally, the virtual textile samples may be joined to one another proximate to a first end of the stack.

In yet another aspect, a carpet sample book comprises an actual carpet sample and a plurality of virtual carpet samples, at least some of which are removable from the sample book. At least one of the virtual carpet samples may comprise a substantially accurate representation of the actual carpet sample. If desired, at least one of the virtual carpet samples may represent an alternate color scheme of the actual carpet sample.

In still another example, a method of providing a customized textile sample comprises providing a user interface, selecting, through the user interface, a textile design to be customized, viewing a virtual representation of the textile design, and selecting a color palette for the textile design. In one example, the method further comprises viewing the virtual representation of the textile design in the selected color palette. In another example, the method further comprises printing the virtual representation of the textile design in the selected color palette. In still another example, the method further comprises requesting a textile specimen of the textile design in the selected color palette.

Various other aspects, features, and advantages of the present invention will become apparent from the following description and accompanying figures.

### BRIEF DESCRIPTION OF THE FIGURES

The file of this patent contains at least one drawing executed in color. Copies of this patent with color drawing(s) will be provided by the Patent and Trademark Office upon request and payment of the necessary fee.

The description refers to the accompanying drawings and figures in which like reference characters refer to like parts throughout the several views, and in which:

FIG. 1A schematically depicts an exemplary textile sample book according to the various aspects of the invention, in a partially open configuration;

FIG. 1B schematically depicts the textile sample book of FIG. 1A in a substantially open configuration;

FIG. 1C depicts a textile specimen;

FIG. 1D depicts a virtual representation of the textile specimen of FIG. 1C, having a different color scheme;

FIG. 1E schematically depicts an exemplary variation of the sample book of FIGS. 1A and 1B;

FIG. 1F schematically depicts another exemplary variation of the sample book of FIGS. 1A and 1B;

FIG. 2 schematically depicts an exemplary textile sample sheet according to the various aspects of the invention; and

FIG. 3 schematically depicts an exemplary textile brochure according to the various aspects of the invention, in a partially open configuration.

### DESCRIPTION

Various aspects of the invention may be illustrated by referring to the figures. For purposes of simplicity, like numerals may be used to describe like features. It will be understood that where a plurality of similar features are depicted, not all of such features necessarily are labeled on each figure. Although several different exemplary aspects, implementations, and embodiments of the various inventions are provided, numerous interrelationships between, combinations thereof, and modifications of the various inventions, aspects, implementations, and embodiments of the inventions are contemplated hereby.

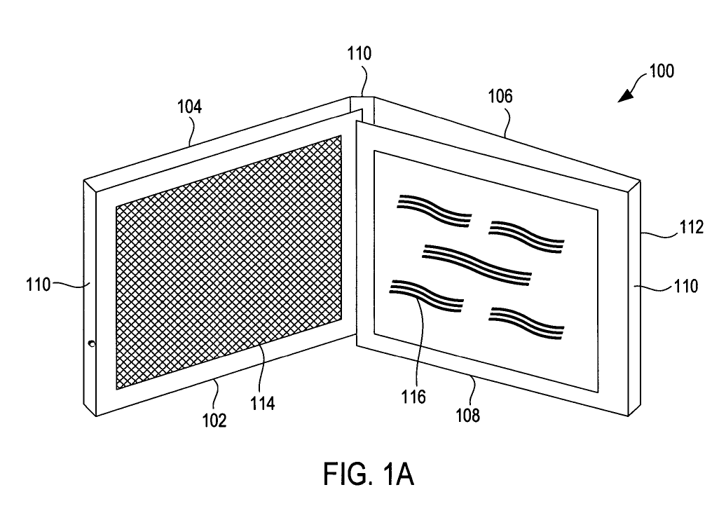

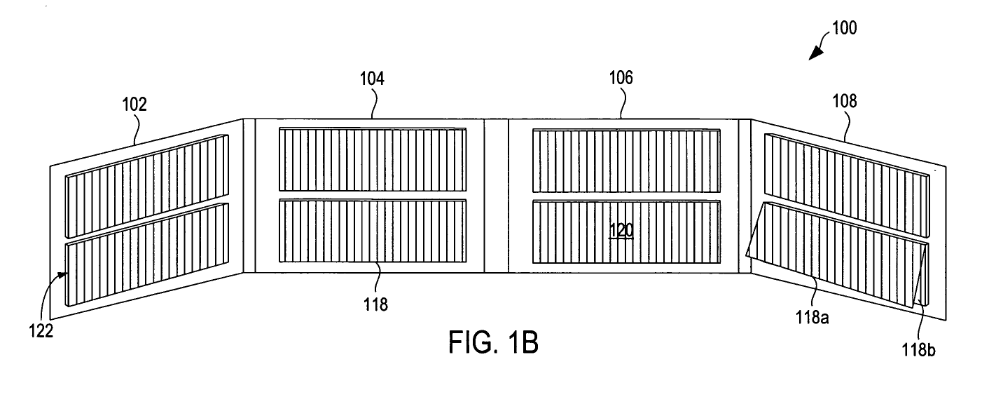

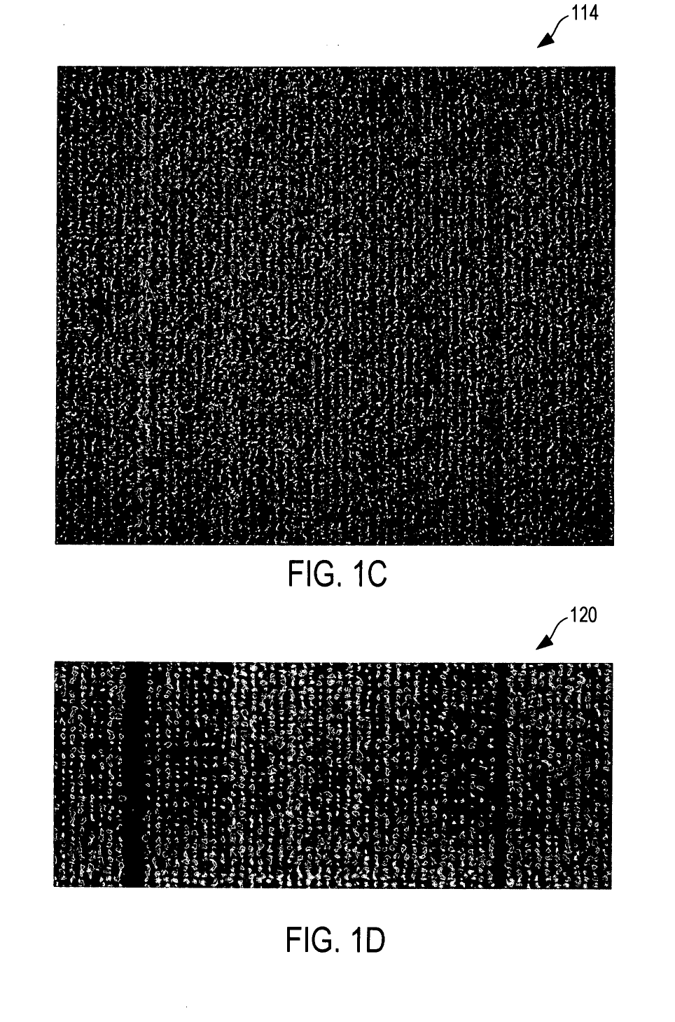

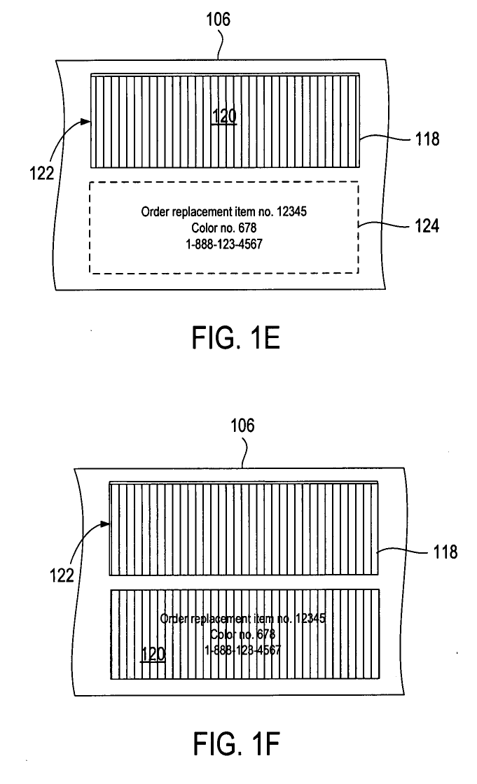

FIG. 1A schematically illustrates a display for textiles, in this example, a sample book 100, in a partially open configuration. The sample book 100 generally includes a plurality of major panels 102, 104, 106, 108 and minor panels 110 joined along a plurality of respective fold lines 112 (only one of which is labeled on FIG. 1A). It will be understood that each major panel 102, 104, 106, 108 includes a pair of opposed, substantially planar faces or sides. However, for purposes of simplicity, such faces or sides will be referred to generally as “panels,” rather than a particular face or side of a panel.

Referring further to FIG. 1A, an actual textile sample or “specimen” 114 overlies and may be joined at least partially to panel 102. Panel 108, opposite panel 102, includes information 116 (schematically illustrated with wavy lines in FIG. 1A) about the textile, the textile manufacturer, care instructions, the textile availability, or any other information. In one example, panel 108 includes a photograph (not shown) of the textile in use, for example, as a floor covering in a room.

FIG. 1B schematically depicts the sample book 100 in a substantially open configuration, which reveals an exemplary collection or display of virtual textile samples 118 overlying panels 104, 106. Each virtual textile sample 118 (only some of which are labeled in FIG. 1B) comprises a sheet or card including a printed representation 120 of a textile, in this example, a tufted carpet. The virtual textile samples 118 generally depict a textile having the same design as the textile specimen 114, but in various color schemes. For example, one virtual textile sample may illustrate a particular textile design using black and ivory, while another may illustrate the same textile design using brown and taupe. Yet another virtual textile sample may illustrate the textile in the same color scheme as the textile specimen, for example, blue and white.

Each representation 120 generally comprises a substantially accurate, high-resolution, graphic image of a tufted carpet or other textile of sufficient quality that it resembles a photograph of the textile with the colors and tufting or weaving pattern clearly and accurately depicted, both visually and dimensionally. For example, FIG. 1C depicts an exemplary textile specimen 114 having a somewhat green color scheme. FIG. 1D depicts an exemplary representation 120 of the textile specimen 114 in an alternate, grey color scheme. Thus, the sample book 100 may include a textile specimen 114 for visual and tactile inspection, in addition to a plurality of optional color variations presented as virtual textile samples 118. In this manner, all or a portion of a particular textile collection may be viewed without requiring a large number of bulky and costly textile specimens 114.

A representation of a textile used in accordance with the invention may be prepared in numerous ways. By way of example, and not limitation, the representation may be prepared by taking a digital photograph of each specimen, including each color scheme variation. As another example, the representation may be prepared by taking a digital photograph of a single textile specimen having a particular color scheme, and then digitally altering the representation to depict the textile in one or more alternate color schemes. However, it will be understood that a representation used in accordance with the invention may be prepared using any suitable combination of photography and digital imaging, as needed for a particular application. It also is contemplated that the representation may be formed using imaging software and/or techniques, without the use of photography. The representation may be displayed on paper or any other suitable material using printing or other techniques to form the virtual textile sample. The representation may be printed at a print resolution of at least about 300 dots per inch (dpi), and in particular examples, the representation is printed at a resolution of about 600 dpi, 1200 dpi, 2400 dpi, 4800 dpi, or 9600 dpi.

Returning to FIG. 1B, multiple virtual textile samples 118 of one or more of the color schemes may be provided as a stack 122 of individually removable sheets or cards, so that one or more virtual textile samples 118 may be removed from the stack 122 for later viewing, while leaving additional virtual textile samples 118 available for viewing and/or removal by others. For instance, outermost virtual textile sample 118a is at least partially superposed with and is at least partially joined to next virtual textile sample 118b depicting the textile specimen 114 in the same color scheme. To remove the outermost virtual textile sample 118a, virtual textile sample 118a may be grasped and pulled away from the next virtual textile sample 118b in the stack 122. In doing so, what was previously the “next” sample in the stack is advanced to being the outermost sample. This process may be continued until the stack 122 is depleted. Alternatively, it will be understood that the virtual textile samples may be removed in any order, such that the outermost virtual textile sample may remain in the stack while one or more of the virtual textile samples behind it are removed. Once a virtual textile sample is removed, it may be retained for later viewing by a potential purchaser, may be discarded, or may be used in any other manner as desired.

The plurality of virtual textile samples 118 in a particular stack 122 may be joined in any suitable matter. For example, a low-tack pressure sensitive adhesive may be applied to at least a portion of the back and/or front of each virtual textile sample 118, such that adjacent virtual textile samples in the stack are adhered removably to one another. Alternatively, the virtual textile samples 118 may be joined proximate to an end of the stack, for example, along one edge, using conventional adhesive binding techniques. Alternatively still, the virtual textile samples 118 may be joined proximate to an end of the stack, for example, along one edge, and provided with perforations, such that a virtual textile sample may be removed by tearing along the line of perforation. Still other means of joining the virtual textile samples are contemplated. In another example, the virtual textile samples 118 are provided as individual, unjoined virtual textile samples arranged in a stacked configuration and contained within a pocket, sleeve, or other holder (not shown). Numerous other possibilities for presenting the virtual textile samples are contemplated by the invention.

It will be evident that the textile sample book and other displays of the invention provide numerous advantages over the conventional sales and marketing practices. Specifically, by including both a textile specimen and one or more virtual textile samples, a viewer is able to evaluate the visual and tactile aesthetics of a plurality of textiles without the need for multiple, cumbersome, costly textile specimens to be produced and/or provided by the manufacturer. Furthermore, the viewer is able to remove and/or retain one or more virtual textile samples to evaluate the visual aspects of the textile in its intended location for use, and/or with other decorating components, or in any other location or manner as desired, without having to obtain and/or transport a large number of textile specimens.

If desired, the sample book 100 may include information about the particular virtual textile samples 118, and/or stacks 122 thereof, that need to be replaced, for example, the color or style name, identification number, and contact information for whom to call to obtain a replacement stack. Such information may be provided on the particular panel, for example, panel 106, in the area 124 to be covered by the particular stack of virtual textile samples (indicated with dashed lines), as shown in partial view in FIG. 1E, on the final virtual textile sample in a stack, or in any other suitable place.

Alternatively or additionally, the final virtual textile sample in a stack may be joined substantially to the panel so the representation can be viewed until a replacement stack is obtained. In this manner, even when a stack of virtual textile samples has been depleted, the particular textile design and color scheme may still be viewed. Alternatively still, the particular representation may be printed onto the panel directly. In either example, stack replacement information may overlie the representation 120, as illustrated in partial view in FIG. 1F, or may be provided in any other suitable manner.

It will be understood that the representations may be presented in various ways according to the invention. For example, while the above representations are embodied in a sample book, the representations may be presented as a single display sheet, a brochure, a booklet, in electronic form, or in any tangible or intangible medium as desired. Any of such media may include any number of pages or panels joined in any suitable manner, for example, as panels joined along fold lines, as sheets joined using conventional adhesive or mechanical binding techniques, or any other manner or configuration.

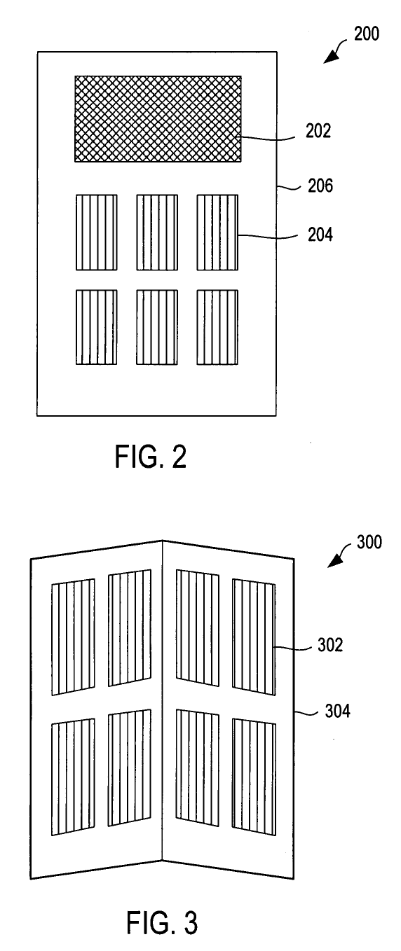

For example, FIG. 2 illustrates a sample sheet 200 including a textile specimen 202 and a plurality of virtual representations 204 of a textile (also referred to as “virtual textile representations”) printed onto or substantially joined to a dimensionally stable substrate 206. Such a sample sheet 200 may be intended to be provided to the potential purchaser and retained for later viewing. In one variation (not shown), the sample sheet may enlarged and may include removable virtual textile samples if desired. Such a display may be suitable for use during trade shows, conferences, technical presentations, or otherwise.

As another example, FIG. 3 illustrates a brochure 300 that includes plurality of virtual textile representations 302 printed onto or substantially joined to a dimensionally stable substrate 304, without a textile specimen being provided. The various representations 302 may be printed onto the substrate 304 directly or may be printed separately and joined to the substrate 304 using an adhesive, a mechanical fastener, or otherwise.

While the above examples include a single textile design in multiple color schemes, the various displays of the invention may include virtual textile representations and/or virtual textile samples depicting multiple textile collections, patterns, colors, and designs. In this manner, one or more textile collections may be presented without the need for numerous textile specimens. However, such displays may include one or more textile specimens if desired.

The virtual textile representations, samples, and/or stacks thereof may have the same or similar shape and size, or may have differing shapes and sizes, and may be arranged on the display in any suitable manner. In the various examples shown herein, each representation, sometimes embodied in a virtual textile sample, is generally rectangular, sized generally equally, and arranged in a tiled configuration with spaces therebetween. However, numerous other shapes and configurations are contemplated hereby. For example, one or more representations and/or virtual textile samples may be presented in a staggered, overlapping, spaced, abutting, or any other arrangement, or any combination thereof. Other examples of shapes include, but are not limited to, circles, squares, triangles, pentagons, hexagons, or any other regular or irregular shape.

In some instances, a particular color scheme may not be included within a sample book, sheet, brochure, or other display. In such instances, the potential buyer may be provided with information on the sample book (or otherwise) directing them to an online color customization program maintained, hosted, or otherwise sponsored by the carpet manufacturer, distributor, or other provider. The program may be accessible by the general public via the internet or may be restricted to users have been provided with login information by the manufacturer.

Once within the program, the user may select a particular pattern in the system and modify it using a palette of available colors provided by the manufacturer. The program then may display the virtual textile representation in the desired color scheme. In this manner, a user may view numerous color schemes and patterns in a relatively short amount of time. When the user has made one or more selections, the user may be provided with the option to print the image, save or download the image, or request that a textile specimen be made by the manufacturer. This significantly streamlines an otherwise iterative process of requesting, preparing, and evaluating specimens before a purchasing decision can be made.

Although certain embodiments of this invention have been described with a certain degree of particularity, those skilled in the art could make numerous alterations to the disclosed embodiments without departing from the spirit or scope of this invention. Any directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention as defined in the appended claims. The detailed description set forth herein is not intended nor is to be construed to limit the present invention or otherwise to exclude any such other embodiments, adaptations, variations, modifications, and equivalent arrangements of the present invention.

Additionally, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific aspects and/or embodiments, it is to be understood that this detailed description is only illustrative and exemplary of the present invention and is made merely for purposes of providing a full and enabling disclosure of the present invention and the best mode known to the inventors of practicing the inventors. The detailed description set forth herein is not intended nor is to be construed to limit the present invention or otherwise to exclude any such other embodiments, adaptations, variations, modifications, and equivalent arrangements of the present invention.

What is claimed is:

1. A display for a textile, comprising:
a textile specimen; and
a virtual representation of the textile specimen.

2. The display of claim 1, wherein the virtual representation of the textile specimen comprises a substantially accurate image of the textile specimen.

3. The display of claim 2, wherein the substantially accurate image comprises a photograph, a digitally altered photograph, an electronically-generated image, or any combination thereof.

4. The display of claim 1, wherein the virtual representation of the textile specimen is printed onto a substrate.

5. The display of claim 4, wherein
the display comprises at least one panel, and
the virtual representation of the textile specimen printed onto the substrate is removably joined to the panel.

6. The display of claim 4, wherein
the display comprises at least one panel, and
the virtual representation of the textile specimen printed onto the substrate is not removably joined to the panel.

7. The display of claim 1, wherein
the textile specimen is provided in a first color scheme,
the virtual representation of the textile specimen is a first virtual representation of the textile specimen in the first color scheme, and
the display further comprises a second virtual representation of the textile specimen in a second color scheme.

8. A display for a textile comprising:
a textile specimen having a color scheme; and
a set of removable cards, each of the cards comprising a substantially accurate representation of the textile specimen having the first color scheme.

9. The display of claim 8, further comprising a dimensionally stable panel, wherein the set of removable cards is removably affixed to the dimensionally stable panel.

10. The display of claim 9, wherein the set of removable cards overlies a substantially accurate representation of the textile specimen having the first color scheme adjoined to the dimensionally stable panel.

11. The display of claim 8, wherein the set of removable cards is arranged in a stacked configuration.

12. The display of claim 8, wherein
the set of removable cards is arranged as a stack, and
the removable cards are adjoined to one another proximate to a first end of the stack.

13. The display of claim 8, wherein each of the removable cards in the set of removable cards is adjoined to an adjacent card by an adhesive.

14. The display of claim 8, wherein the set of removable cards is arranged as a stack with an outermost card at least partially concealing a next card, and upon removal of the outermost card, the next card becomes available for removal.

15. The display of claim 8, wherein
the set of removable cards is a first set of removable cards,
the display further comprises a second set of removable cards, and
each of the cards in the second set of removable cards comprises a substantially accurate representation of the textile specimen having a second color scheme.

16. A plurality of virtual textile samples in a stack, wherein each virtual textile sample comprises a substantially accurate representation of a textile specimen.

17. The plurality of virtual textile samples of claim 16, wherein adjacent virtual textile samples in the stack are joined to one another using an adhesive.

18. The plurality of virtual textile samples of claim 16, wherein the virtual textile samples are joined to one another proximate to a first end of the stack.

19. A carpet sample book comprising:
an actual carpet sample; and
a plurality of virtual carpet samples, at least some of which are removable from the sample book.

20. The carpet sample book of claim 19, wherein at least one of the virtual carpet samples comprises a substantially accurate representation of the actual carpet sample.

21. The carpet sample book of claim 20, wherein at least one of the virtual carpet samples represents an alternate color scheme of the actual carpet sample.

22. A method of providing a customized textile sample, comprising:
providing a user interface;
selecting, through the user interface, a textile design to be customized;
viewing a virtual representation of the textile design; and
selecting a color palette for the textile design.

23. The method of claim 22, further comprising viewing the virtual representation of the textile design in the selected color palette.

24. The method of claim 22, further comprising printing the virtual representation of the textile design in the selected color palette.

25. The method of claim 22, further comprising requesting a textile specimen of the textile design in the selected color palette.
